(19) United States
(12) Patent Application Publication
(10) Pub. No.: US 2013/0020302 A1
(43) Pub. Date: Jan. 24, 2013

(54) HEATING MODULE FOR MAINTAINING BATTERY WORKING TEMPERATURE

(71) Applicant: Tzu-Chin Chiu, New Taipei City (TW)

(72) Inventor: Tzu-Chin Chiu, New Taipei City (TW)

(21) Appl. No.: 13/187,727

(22) Filed: Jul. 21, 2011

(51) Int. Cl. H05B 1/00

(52) U.S. Cl. 219/201

(57) ABSTRACT

A heating module for maintaining battery working temperature is arranged adjacent to one side of a battery, and includes a plurality of radiating fins and at least one heating unit. The heating unit includes at least one heating element and at least one heat transfer element, and the heat transfer element is perpendicularly extended through the radiating fins. An air guiding element is disposed between the heating module and the battery or adjacent to one side of the radiating fins opposite to the battery, so as to force air flows, which carry heat radiated from the radiating fins, toward the battery to thereby effectively raise the ambient temperature surrounding the battery, allowing the battery to reach its working temperature and work normally.

### FIELD OF THE INVENTION

The present invention relates to a heating module, and more particularly to a heating module for maintaining battery working temperature.

### BACKGROUND OF THE INVENTION

In the occasion where household AC power or general DC power is not available, a battery is usually used to supply electric power. For instance, various kinds of vehicles, lamps, power tools, electronic devices, communication devices and heat exchangers all can use one or more batteries to obtain required power supply. For some large-scale apparatus that require relative high power supply, one or more battery boxes may be equipped to supply the required electric power. In the battery box, there are multiple battery modules, and each of the battery modules includes a plurality of battery cells.

Generally, a battery could not be normally charged and discharged when it works in an environment having an ambient temperature lower than 0° C. Particularly, when the working environment has a low temperature from about −20° C. to about −30° C., the battery could not be activated to supply power at all. Therefore, in extremely cold areas or countries and in working places that require very low temperature, special measures have been taken to maintain the batteries at their working temperature. That is, while it is necessary to consider the dissipation of heat from a battery box, particular attention must also be paid to a suitable heating system for battery box working under low temperature.

According to a conventional heating system for battery box, a heat source is directly provided inside the battery box, and heat generated by the heat source is transferred to the battery cells in the battery box via radiation, in order to raise the ambient temperature surrounding the battery cells. However, since the transfer of heat via radiation has low heat transfer efficiency, the battery box could not effectively reach its working temperature with the conventional heating system for battery box.

In brief, the conventional technique for raising the temperature in a battery box has the following disadvantages: (1) the transfer of heat via radiation has low heat transfer efficiency; and (2) the battery could not effectively reach its working temperature.

It is therefore tried by the inventor to overcome the above-mentioned problems by developing a heat module for maintaining battery working temperature.

### SUMMARY OF THE INVENTION

A primary object of the present invention is to provide a heating module that is used to raise the ambient temperature surrounding a battery, so that the battery can reach its working temperature to supply power in a normal manner.

To achieve the above and other objects, the heating module according to the present invention is arranged adjacent to a battery and includes a plurality of radiating fins and at least one heating unit. The heating unit includes at least one heating element and at least one heat transfer element, and the heat transfer element is perpendicularly extended through the radiating fins. An air guiding element is disposed between the heating module and the battery or adjacent to one side of the radiating fins opposite to the battery, so as to force air flows, which carry heat radiated from the radiating fins, toward the battery to thereby effectively raise the ambient temperature surrounding the battery, allowing the battery to reach its working temperature and work normally.

With the above arrangements, the heating module of the present invention has the following advantages: (1) being able to effectively raise the ambient temperature surrounding a battery; and (2) enabling a battery to effectively reach its working temperature and supply power in a normal manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a heating module for maintaining battery working temperature according to a first preferred embodiment of the present invention;

FIG. 2A shows the use of the heating module of FIG. 1 with an air guiding element;

FIG. 2B shows the use of the heating module and the air guiding element of FIG. 2A to maintain battery working temperature;

FIG. 3 is a perspective view of a heating module for maintaining battery working temperature according to a second preferred embodiment of the present invention;

FIG. 4A shows the use of the heating module of FIG. 3 with an air guiding element;

FIG. 4B shows the use of the heating module and the air guiding element of FIG. 4A to maintain battery working temperature;

FIG. 5 is a perspective view of a heating module for maintaining battery working temperature according to a third preferred embodiment of the present invention;

FIG. 6 is a perspective view of a heating module for maintaining battery working temperature according to a fourth preferred embodiment of the present invention;

FIG. 7 is a perspective view of a heating module for maintaining battery working temperature according to a fifth preferred embodiment of the present invention; and

FIG. 8 is a perspective view of a heating module for maintaining battery working temperature according to a sixth preferred embodiment of the present invention; and

FIG. 9 is a perspective view of a heating module for maintaining battery working temperature according to a seventh preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

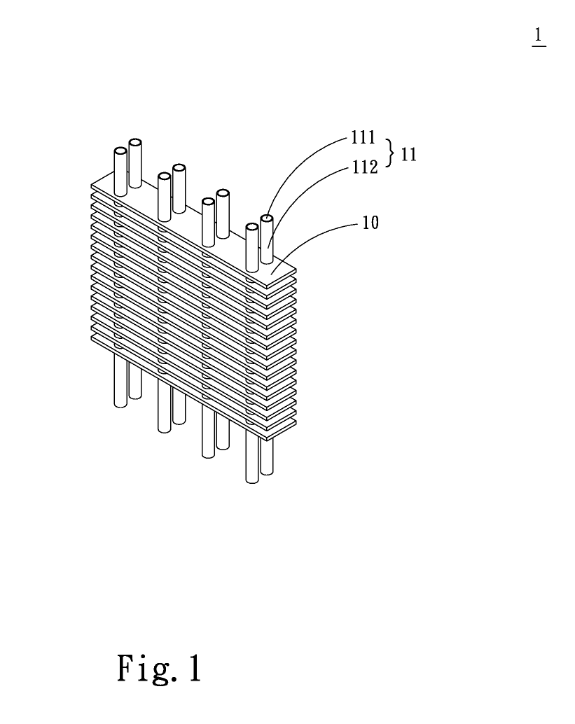

Please refer to FIG. 1 that is a perspective view of a heating module for maintaining battery working temperature according to a first preferred embodiment of the present invention. For the purpose of conciseness, the present invention is also briefly referred to as a heating module herein and is generally denoted by reference numeral 1. As can be seen in FIG. 1, the heating module 1 includes a plurality of radiating fins 10 and at least one heating unit 11. The radiating fins 10 are vertically stacked with a space left between any two adjacent ones of the radiating fins 10.

The heating unit 11 includes at least one heating element 111 and at least one heat transfer element 112. The heat transfer element 112 is perpendicularly extended through the stacked and spaced radiating fins 10, and the heating element 111 is in contact with the heat transfer element 112. In the illustrated first preferred embodiment, the heating element 111 and the heat transfer element 112 can be a heating rod and a copper pipe, respectively, without being limited thereto. The heating element 111 is disposed inside the heat transfer element 112, such that when the heating element 111 is supplied with an electric current and generates heat, the generated heat is transferred to and absorbed by the heat transfer element 112.

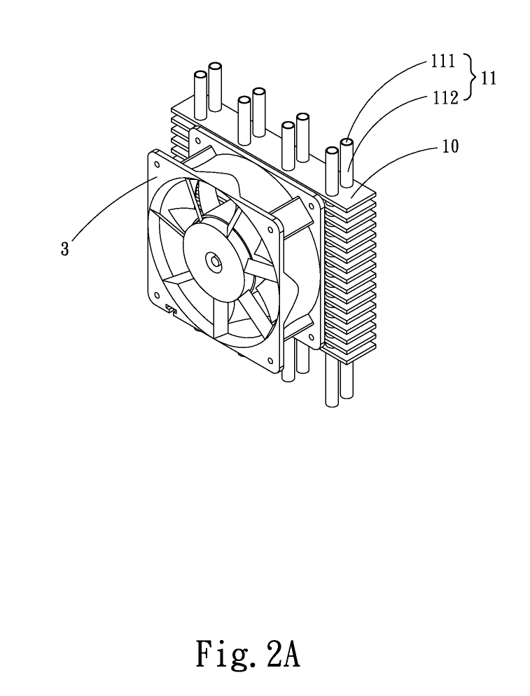

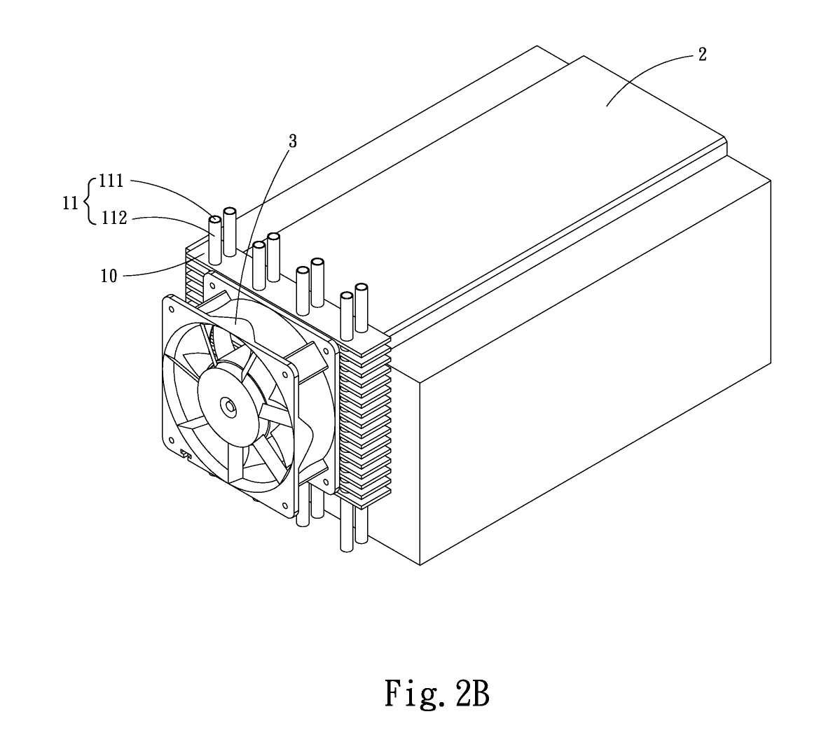

Please refer to FIGS. 2A and 2B along with FIG. 1. As shown, the heating module 1 is arranged adjacent to one side of a battery 2, and an air guiding element 3 can be arranged to one side of the heating module 1 opposite to the battery 2. Alternatively, although not shown in the drawings, the air guiding element 3 can be arranged between the heating module 1 and the battery 2. When the heating element 111 is supplied with an electric current and accordingly generates heat, the generated heat is transferred to and absorbed by the heat transfer element 112 and the radiating fins 10. The air guiding element 3 functions to produce air flows toward the heating element 111, so that the heat generated by the heating element 111 is carried by the air flows toward the battery 2 to thereby raise the ambient temperature surrounding the battery 2, allowing the battery 2 to supply power in a normal manner when it reaches its working temperature. At this point, the heating element 111 automatically stops heating.

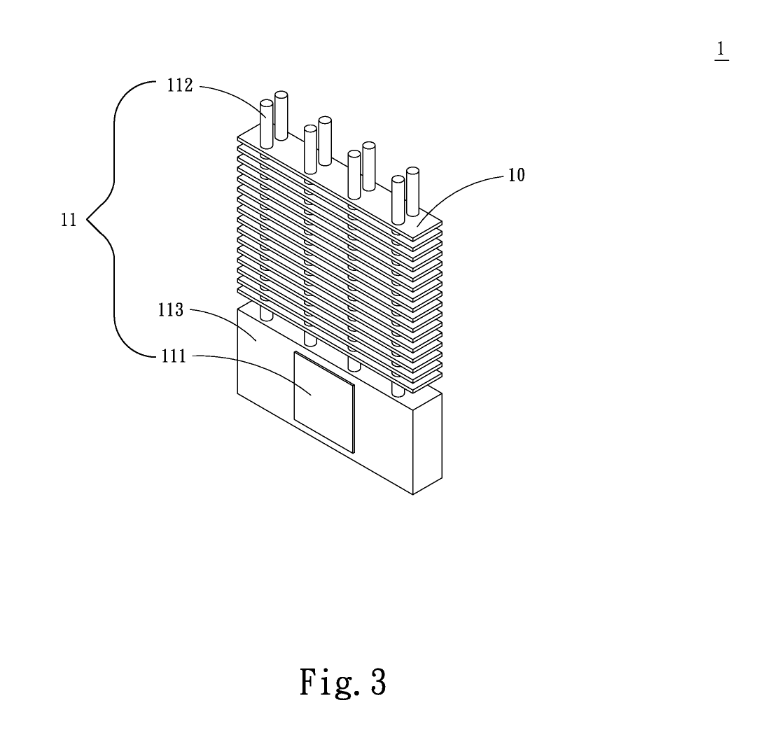

FIG. 3 is a perspective view of a heating module for maintaining battery working temperature according to a second preferred embodiment of the present invention. As shown, in the second embodiment, the heating module 1 includes a plurality of radiating fins 10 and at least one heating unit 11. The radiating fins 10 are vertically stacked with a space left between any two adjacent ones of the radiating fins 10.

The heating unit 11 includes at least one heating element 111 and at least one heat transfer element 112. The heat transfer element 112 is perpendicularly extended through the stacked and spaced radiating fins 10, and the heating element 111 is indirectly connected to the heat transfer element 112. In the illustrated second preferred embodiment, the heating element 111 and the heat transfer element 112 can be a heating plate and a heat pipe, respectively, without being limited thereto. The heat transfer element 112 is connected at an end to a bottom plate 113, and the heating element 111 is connected to one side of the bottom plate 113 to locate adjacent to the end of the heat transfer element 112 connected to the bottom plate 113. That is, the heating element 111 is indirectly connected to the heat transfer element 112 via the bottom plate 113. When the heating element 111 generates heat, the generated heat is absorbed by the bottom plate 113 and the heat transfer element 112.

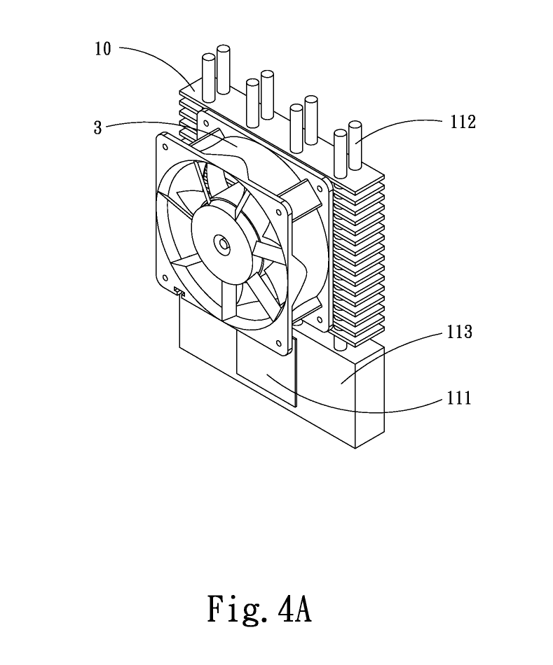

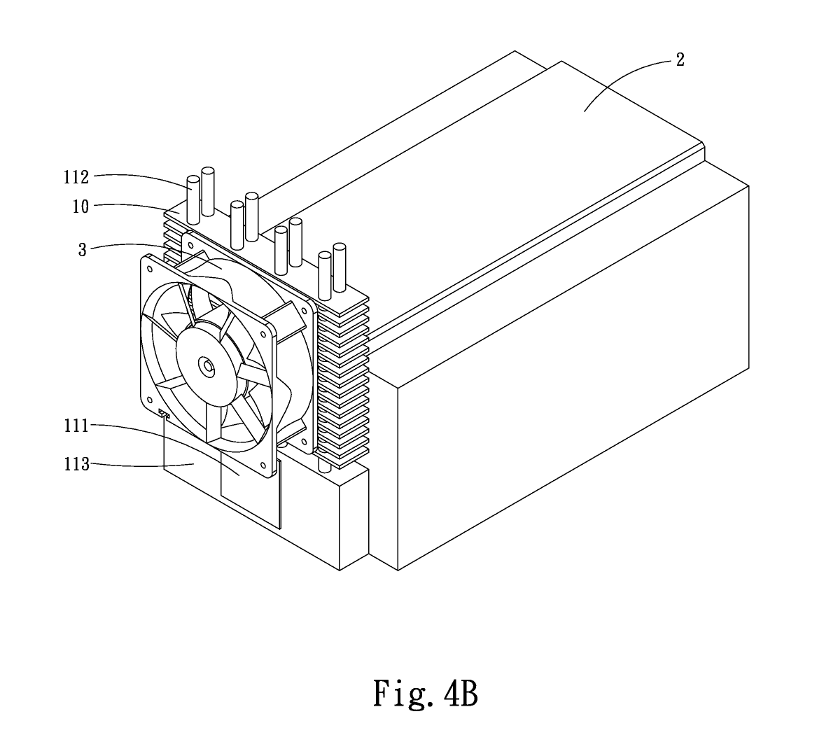

Please refer to FIGS. 4A and 4B along with FIG. 3. As shown, the heating module 1 according to the second embodiment of the present invention is arranged adjacent to one side of a battery 2, and an air guiding element 3 can be arranged to one side of the heating module 1 opposite to the battery 2. Alternatively, although not shown in the drawings, the air guiding element 3 can be arranged between the heating module 1 and the battery 2. When the heating element 111 generates heat, the generated heat is transferred via the bottom plate 113 to the heat transfer element 112 and the radiating fins 10 and absorbed by the same. The air guiding element 3 functions to produce air flows toward the heating element 111 and the radiating fins 10, so that the heat generated by the heating element 111 is carried by the air flows toward the battery 2 to thereby raise the ambient temperature surrounding the battery 2, allowing the battery 2 to supply power in a normal manner when it reaches its working temperature. At this point, the heating element 111 automatically stops heating.

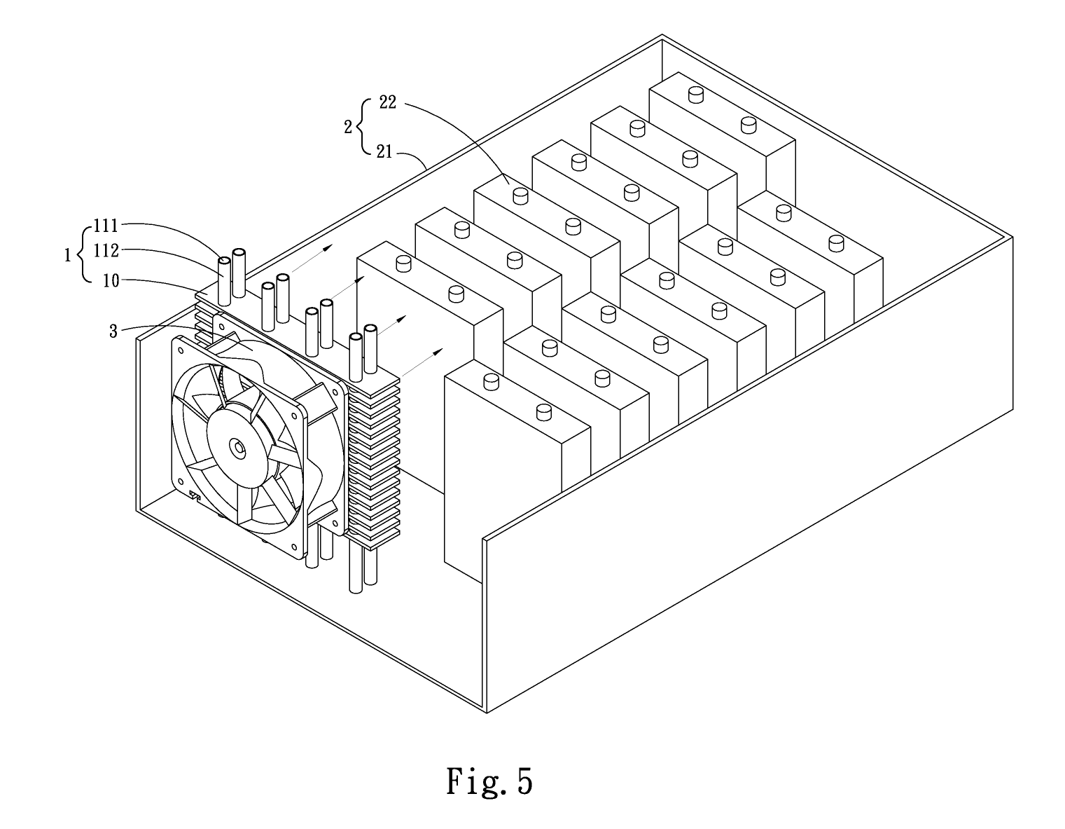

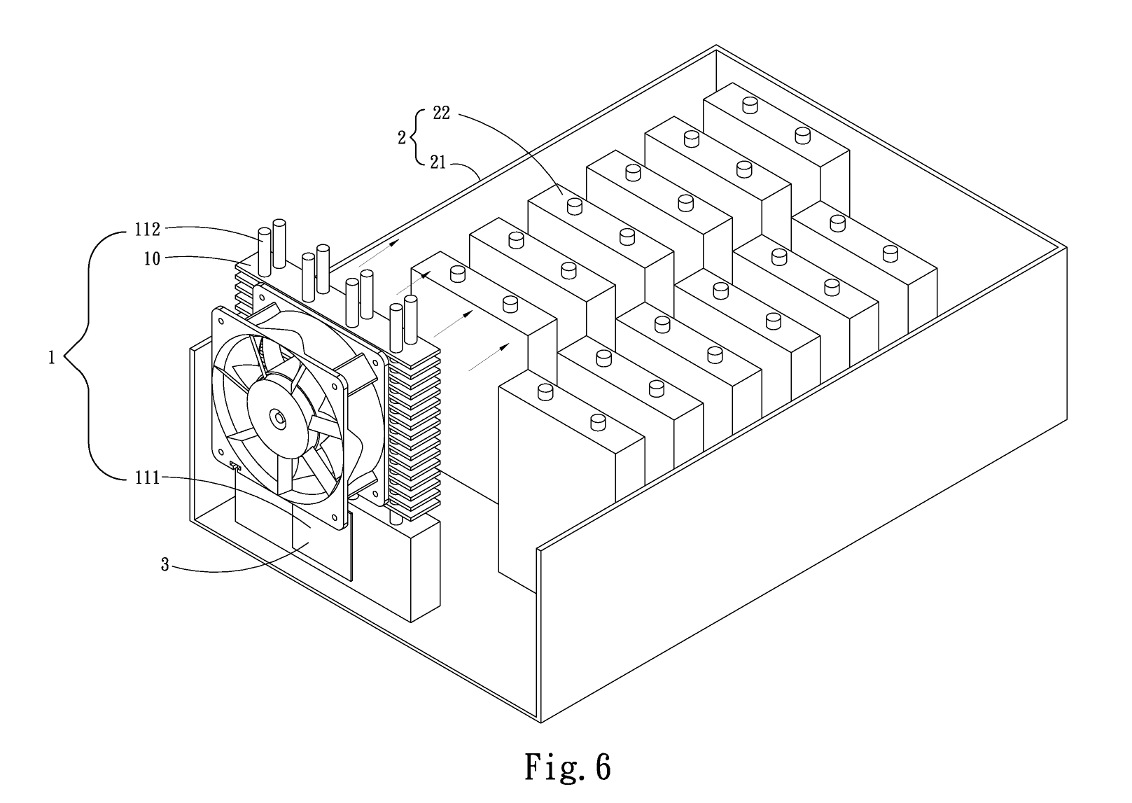

FIGS. 5 and 6 are perspective views showing the heating module 1 according to a third and a fourth preferred embodiment of the present invention, respectively. The third and the fourth embodiment are generally structurally similar to the first and the second embodiment, respectively, except that the heating module 1 is mounted in an enclosure 21 of the battery 2, which includes a plurality of battery cells 22 arrayed in the enclosure 21. When the heating element 111 is supplied with an electric current and generates heat, the generated heat is absorbed by the heat transfer element 112 and the radiating fins 10. The air guiding element 3 produces air flows toward the heating element 111, so that the heat generated by the heating element 111 is carried by the air flows toward the battery cells 22 in the enclosure 21 of the battery 2 to raise the ambient temperature surrounding the battery cells 22, allowing the battery 2 to supply power in a normal manner when it reaches its working temperature.

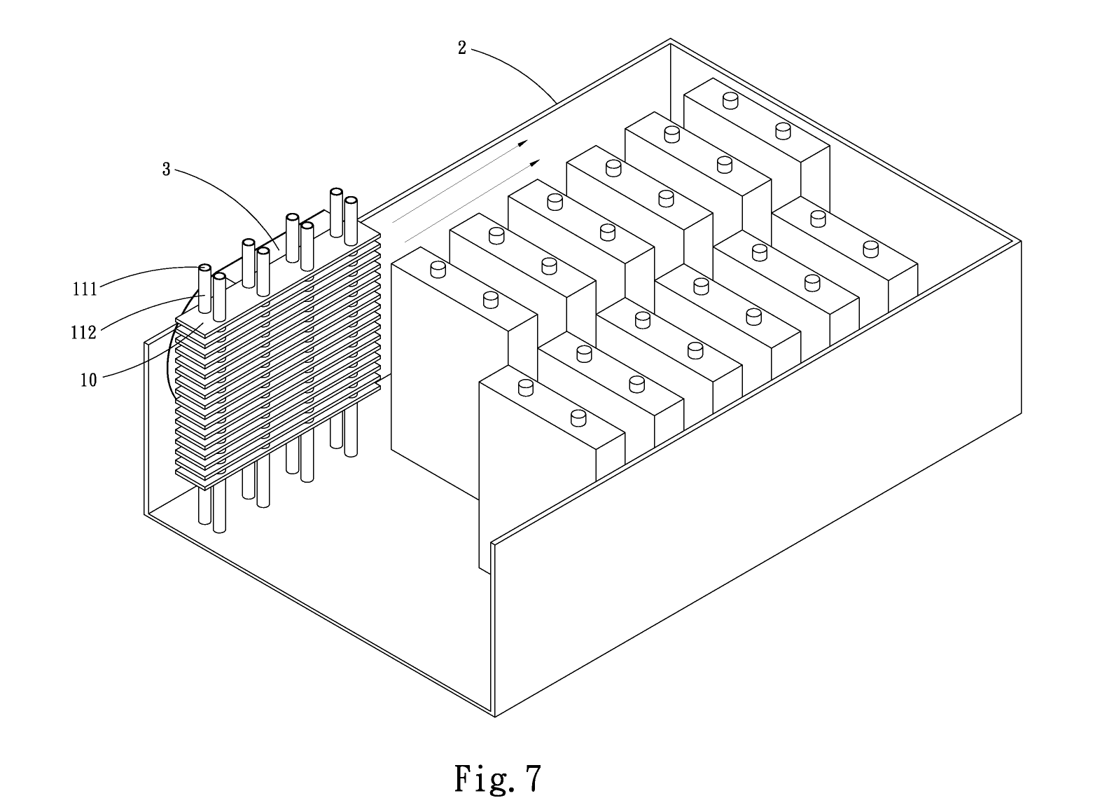

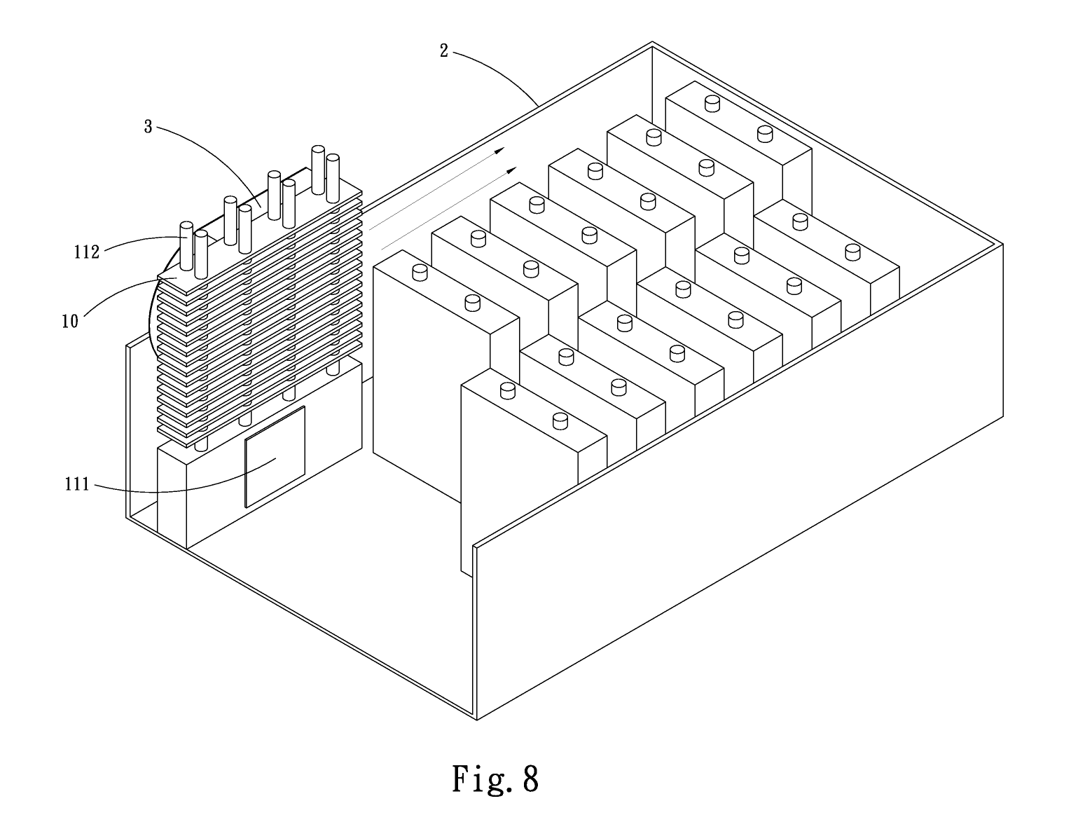

FIGS. 7 and 8 are perspective views showing the heating module 1 according to a fifth and a sixth embodiment of the present invention, respectively. The fifth and the sixth embodiment are generally structurally similar to the third and the fourth embodiment, respectively, except that the heating module 1 is used with an air guiding element 3 in the form of a centrifugal fan instead of an axial fan. When the heating element 111 is supplied with an electric current and generates heat, the generated heat is absorbed by the heat transfer element 112 and the radiating fins 10. The air guiding element 3 sucks in the heat generated by the heating element 111 and the heat absorbed by the heat transfer element 112 and the radiating fins 10, and blows air flows carrying the sucked heat toward the battery cells 22 in the enclosure 21 of the battery 2 to raise the ambient temperature surrounding the battery cells 22, allowing the battery 2 to supply power in a normal manner when it reaches its working temperature.

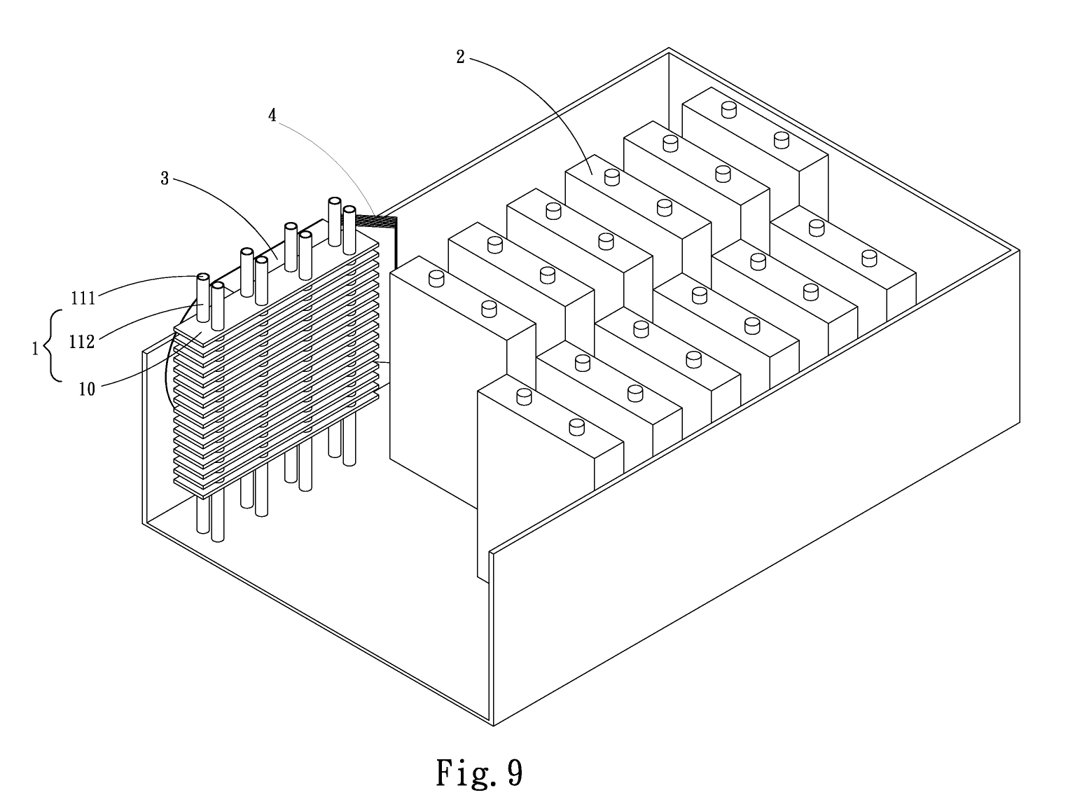

FIG. 9 shows a seventh embodiment of the present invention. As shown, the seventh embodiment is generally structurally similar to the fifth and the sixth embodiment, except that the heating module 1 further includes an air flow passage 4 located at a position corresponding to the heating unit 11. In the illustrated seventh embodiment, the air flow passage 4 has an end located adjacent to one side of the heating unit 11 corresponding to an air outlet of the air guiding element 3 and another opposite end located adjacent to and facing toward the battery cells 22. Therefore, hot air flows carrying the sucked heat can be more effectively sent to the battery cells 22 according to actual need.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heating module for maintaining battery working temperature and being arranged adjacent to one side of a battery, comprising a plurality of radiating fins and at least one heating unit; the heating unit including at least one heating element and at least heat transfer element, and the heating element being perpendicularly extended through the radiating fins.

2. The heating module for maintaining battery working temperature as claimed in claim 1, wherein the heating element is disposed inside the heat transfer element.

3. The heating module for maintaining battery working temperature as claimed in claim 2, wherein the heat transfer element is a copper pipe, and the heating element is a heating rod.

4. The heating module for maintaining battery working temperature as claimed in claim 1, wherein the heating element is arranged adjacent to an end of the heat transfer element

5. The heating module for maintaining battery working temperature as claimed in claim 4, wherein the heating unit further includes a bottom plate located between the heating element and the heat transfer element; the heat transfer element being connected at an end to the bottom plate, and the heating

6. The heating module for maintaining battery working temperature as claimed in claim 5, wherein the heat transfer element is a heat pipe, and the heating element is a heating plate.

7. The heating module for maintaining battery working temperature as claimed in claim 1, further comprising an air guiding element; the air guiding element being arranged to one side of the radiating fins and the battery being located at another side of the radiating fins opposite to the air guiding element.

8. The heating module for maintaining battery working temperature as claimed in claim 1, wherein the battery includes an enclosure and a plurality of battery cells arrayed in the enclosure; and the heating module being arranged inside the enclosure to locate adjacent to one side of the battery.

9. The heating module for maintaining battery working temperature as claimed in claim 8, further comprising an air flow passage; and the air flow passage having an end located adjacent to the heating unit and another opposite end located adjacent to and facing toward the battery cells.
